(19) United States
(12) Patent Application Publication
(10) Pub. No.: US 2023/0325337 A1
(43) Pub. Date: Oct. 12, 2023

(54) DATA TRANSMISSION DEVICE AND METHOD

(71) Applicant: Institute of Microelectronics, Chinese Academy of Sciences, Beijing (CN)

(72) Inventors: Chong Bi, Beijing (CN); Ming Liu, Beijing (CN)

(73) Assignee: Institute of Microelectronics, Chinese Academy of Sciences, Beijing (CN)

(21) Appl. No.: 18/043,479

(22) PCT Filed: Aug. 28, 2020
(86) PCT No.: PCT/CN2020/112109

§ 371 Date: Feb. 28, 2023

(51) Int. Cl. G06F 13/40

(52) U.S. Cl. CPC G06F 13/4063

(57) ABSTRACT

Provided are a data transmission device and a data transmission method, which are applied to a field of an information technology. The data transmission device includes: a signal conversion module (30) and a signal transmission module (20), wherein the signal conversion module (30) is configured to convert, at a data transmitting end, an electrical signal containing a data information into a magnon signal containing the data information; the signal transmission module (20) is configured to transmit the magnon signal containing the data information to a data receiving end; and the signal conversion module (30) is further configured to convert, at the data receiving end, the magnon signal containing the data information into the electrical signal containing the data information. The data transmission method includes transmitting the data by using the magnon signal, and no voltage or current is required in a process of transmitting the data.

### CROSS-REFERENCE TO RELATED APPLICATION

This application is a Section 371 National Stage Application of International Application No. PCT/CN2020/112109, filed on Aug. 28, 2020, entitled “DATA TRANSMISSION DEVICE AND METHOD”, the content of which is hereby incorporated by reference in its entirety.

### TECHNICAL FIELD

The present disclosure relates to a field of an information technology, and in particular, to a data transmission device and a data transmission method.

### BACKGROUND

In the current processor architecture, a Central Processing Unit (CPU) is usually composed of a logic portion and a data storage portion, and a data exchange is implemented through metal interconnecting lines. A data transmission mode of the data exchange is a voltage pulse. In order to meet the specific frequency of a data transmission, a resistance, a layer number and a voltage applied by the data transmission of the metal interconnecting lines must meet a specific requirement, resulting in problems of a low efficiency of the data transmission, a high power consumption, etc. Especially in fields of an artificial intelligence and a big data processing chip at present, the logic portion and the storage portion require a lot of data exchange. The data transmission mode based on the metal interconnecting lines may not meet a demand for a high-speed data processing, that is, a problem of data “memory wall” may exist. On the other hand, in order to improve a bandwidth of a data transmission between a processor and a peripheral memory or controller, the number of pins of a chip, a PCB wiring and packaging, etc. all face an important challenge. In addition, the increasingly complex data transmission mode may also result in problems of a reliability, a data transmission power consumption, a cost, etc.

### SUMMARY

A main purpose of the present disclosure is to provide a data transmission device and a data transmission method, aiming to solve problems of a complex metal interconnect, a limited bandwidth and a large power consumption faced by a logic portion and a storage portion in an integrated circuit and a data transmission between different chips in the prior art.

In order to implement the above-mentioned purpose, a first aspect of embodiments of the present disclosure provides a data transmission device, including: a signal conversion module and a signal transmission module, wherein
the signal conversion module is configured to convert, at a data transmitting end, an electrical signal containing a data information into a magnon signal containing the data information;
the signal transmission module is configured to transmit the magnon signal containing the data information to a data receiving end; and
the signal conversion module is further configured to convert, at the data receiving end, the magnon signal containing the data information into the electrical signal containing the data information.

Optionally, the signal conversion module has a function of a mutual conversion between a spin and a charge; and
the signal conversion module includes a material or a structure with a spin Hall effect, a Rashba effect or a spin transfer torque effect.

Optionally, a material of the signal transmission module includes a ferromagnetic material or an antiferromagnetic material.

Optionally, the ferromagnetic material is a magnetic alloy containing at least one metallic element of iron, cobalt and nickel, a multilayer heterojunction or a magnetic insulator.

Optionally, the antiferromagnetic material is an antiferromagnetic alloy containing at least one metallic element of iron, cobalt, nickel, manganese and chromium, a multilayer heterojunction or an antiferromagnetic insulator.

Optionally, the ferromagnetic material has a vertical magnetic anisotropy or an in-plane magnetic anisotropy.

Optionally, a Nie Er vector of the antiferromagnetic material is allowed to form an arbitrary angle with a transmission direction of a magnon.

Optionally, the signal conversion module is provided in a functional module to be performed for a data transmission, and the signal conversion module is electrically connected to the functional module.

Optionally, the functional module to be performed a data transmission is in contact with the signal transmission module, so as to transmit a magnon signal containing a to-be-transmitted data information on the signal transmission module.

A second aspect of embodiments of the present disclosure provides a data transmission method, including:
converting, at a data transmitting end, an electrical signal containing a data information into a magnon signal containing the data information by using a signal conversion module;
transmitting the magnon signal containing the data information to a data receiving end by using a signal transmission module; and
converting, at the data receiving end, the magnon signal containing the data information into the electrical signal containing the data information by using the signal conversion module.

### BRIEF DESCRIPTION OF THE DRAWINGS

In order to more clearly illustrate embodiments of the present disclosure or the technical solution in the prior art, accompanying drawings required in embodiments or the descriptions of the prior art will be briefly introduced below. Obviously, the accompanying drawings in the following descriptions are only some embodiments of the present disclosure. For those skilled in the art, other accompanying drawings may further be obtained from the accompanying drawings without any creative work.

FIG. 1 shows a structural schematic diagram of a data transmission device according to an embodiment of the present disclosure;

FIG. 2 shows a structural schematic diagram of an on-chip data transmission chip according to an embodiment of the present disclosure;

FIG. 3 shows a structural schematic diagram after performing an electron beam exposure and an ion etching on a data transmission module according to an embodiment of the application;

FIG. 4 shows a schematic diagram of a sputtered Pt layer according to an embodiment of the present disclosure;

FIG. 5 shows a schematic diagram of a test structure according to an embodiment of the present disclosure;

FIG. 6 shows a schematic diagram of a relationship between a written voltage and a detection voltage based on a test structure according to an embodiment of the present disclosure;

FIG. 7 shows a schematic diagram of a relationship between a 10 nanosecond written voltage pulse sequence and a detection pulse sequence according to an embodiment of the present disclosure; and

FIG. 8 shows a schematic diagram of a flowchart of a data transmission method according to an embodiment of the present disclosure.

### DETAILED DESCRIPTION OF EMBODIMENTS

In order to make objectives, features and advantages of the present disclosure more obvious and understandable, technical solutions in embodiments of the present disclosure will be clearly and completely described below in combination with accompanying drawings in embodiments of the present disclosure. Obviously, the described embodiments are only some, but not all of, embodiments of the present disclosure. Based on embodiments of the present disclosure, all other embodiments obtained by those skilled in the art without any creative work may fall within the scope of protection of the present disclosure.

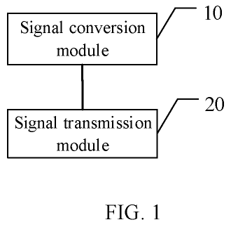

Please refer to FIG. 1. FIG. 1 shows a structural diagram of a data transmission device according to an embodiment of the present disclosure. The data transmission device includes: a signal conversion module and a signal transmission module, wherein the signal conversion module is used to convert, at a data transmitting end, an electrical signal containing a data information into a magnon signal containing the data information; the signal transmission module is used to transmit the magnon signal containing the data information to a data receiving end; and the signal conversion module is further used to convert, at the data receiving end, the magnon signal containing the data information into the electrical signal containing the data information.

The signal conversion module at the data transmitting end and the signal conversion module at the data receiving end may be a same signal conversion module or different signal conversion modules.

Understandably, the signal conversion module may be used to implement a mutual conversion between the electrical signal and the magnon signal, and have a function of a spin charge conversion. The same signal conversion module may transmit and receive data simultaneously. That is, the same signal conversion module may convert the electrical signal into the magnon signal and convert the magnon signal into the electrical signal simultaneously. Certainly, the data may also be transmitted and received at different times. The present disclosure is not limited to this.

Understandably, a material of the signal transmission module that may be used to transmit the magnon signal is a magnetic material. A magnon is similar to a photon. The magnon may propagate by a certain characteristic mode in the magnetic material (signal transmission module), and perform a data encoding through a frequency modulation and an amplitude modulation. Since the magnon of different frequencies may propagate independently in the magnetic material (signal transmission module) without a mutual interference, the magnon signals of different frequency bands may propagate simultaneously in a same signal transmission module, which may greatly improve a data transmission capacity.

In the embodiments, compared with the data transmission device (including a light source and a light wave detector, etc.) based on an optical signal, the present disclosure performs a data transmission using the magnon signal. A transmission and a reception of the magnon signal do not require a complex light source and a complex light wave detector, but only the signal conversion module that may convert the electrical signal and the magnon signal to each other, which may thus be beneficial to integrate the signal conversion module into a large-scale integrated circuit. At the same time, compared with the related data transmission device based on metal interconnecting lines, the magnon signal may non-directionally propagate in the magnetic material without any voltage or current. All regions of the signal transmission module may receive and transmit data. Therefore, the signal transmission module does not required to be micromachined into a specific shape or channel, which may greatly reduce a power consumption and a complexity of the data transmission device. In addition, the magnon signal may also form an ultrashort spin soliton wave pulse, and a waveform and a speed remain unchanged during the transmission, which may further improve an accuracy of the data transmission.

In an embodiment of the present disclosure, the signal conversion module includes a material or a structure with a spin Hall effect, a Rashba effect or a spin transfer torque effect, for example, a magnetic tunnel junction or an interface between two materials.

The signal conversion module has a spin Hall effect, a Rashba effect or a spin transfer torque effect. That is, the signal conversion module includes the material or the structure with the spin Hall effect, the Rashba effect or the spin transfer torque effect, which includes at least one selected from a heavy metal material, a ferromagnetic material, an antiferromagnetic material, a two-dimensional material, a topological material or a magnetic tunnel junction. The material with the spin Hall effect or the Rashba effect includes, for example, Pt, W, Ta, Cr, Mn, Co, Ni, CoFeB, NiFe, IrMn, PtMn, WTe₂, WSe₂, Bi₂Se₃, MoS₂, etc. For example, the magnetic tunnel junction is a CoFeB/MgO/CoFeB tunnel junction. The interface between the two materials is a W/Pt interface, an SrTiO3/LaAlO3 interface, a Bi/Ag interface, etc.

The magnetic tunnel junction is composed of two ferromagnetic layers separated by a tunneling layer, and a resistance of the magnetic tunnel junction depends on opposite magnetization directions of the two ferromagnetic layers. When the magnetization directions of the two ferromagnetic layers are parallel to each other, the magnetic tunnel junction is in a low resistance state. When the magnetization directions of the two ferromagnetic layers are antiparallel to each other, the magnetic tunnel junction is in a high resistance state. A resistance of the magnetic tunnel junction is very sensitive to the magnetization direction of any one of the ferromagnetic layers. Therefore, if one of the two ferromagnetic layers of the magnetic tunnel junction is also the signal conversion module or a signal conversion module closely adjacent to the magnon signal, any change in the magnon signal in the signal conversion module may result in a change in the resistance of the magnetic tunnel junction. That is, a conversion from the magnon signal to the electrical signal may be implemented. When a current is applied to the magnetic tunnel junction, the current may also be polarized and thus produce a spin current. The spin flow may also change a distribution of magnon in the signal transmission module, so as to implement a conversion from the electrical signal to the magnon signal.

For the materials with the spin Hall effect (SHE) or the Rashba effect, a spin current and a current in the materials may be converted into each other through a spin-orbit coupling. That is, the current passing through the materials may form a certain spin accumulation on a surface of the materials (called the spin Hall effect or the Rashba effect) or convert the spin current injected into an interface of the materials into the current (called an inverse spin Hall effect (ISHE) or an inverse Rashba effect). Therefore, the materials, like the magnetic tunnel junction, may also implement a mutual conversion from the electrical signal to the magnon signal through a mutual conversion between a charge and a spin.

In an embodiment of the present disclosure, a material of the signal transmission module includes a ferromagnetic material or an antiferromagnetic material.

An electronic spin in a region inside the ferromagnetic material or the antiferromagnetic material may have small disturbances due to a thermal disturbance or for some external reasons. The small disturbances may propagate to other regions through an exchange coupling effect. In general, when a temperature is above absolute zero, a disturbance of the temperature dominates. Therefore, when the temperature is above absolute zero, the ferromagnetic material or the antiferromagnetic material may form magnon with an energy, a number and a frequency conforming to a certain distribution.

In general, a magnon frequency of the ferromagnetic material is in an order of GHz, and an magnon frequency of the antiferromagnetic material is in an order of THz. However, the magnon excited in the antiferromagnetic material has a control difficulty greater than that in the ferromagnetic material. The magnon has an intrinsic bandwidth and energy distribution in the ferromagnetic material or the antiferromagnetic material, which may depend on a specific magnetic material and structure. In addition to the above-mentioned disturbance of the temperature, the signal conversion module may further create a spin accumulation on a surface of the ferromagnetic material or the antiferromagnetic material or apply a microwave field to disturb the magnon, so as to change a distribution of the magnon, that is, a modulation of a signal at a transmitting end may be implemented. The magnon in the ferromagnetic material or the antiferromagnetic material may further affect an internal spin state of the signal conversion module in contact with the magnon through the exchange coupling or other proximity effects, so as be perceived by the signal conversion module, that is, a reading and a demodulation of the magnon signal at a signal receiving end may be implemented.

Optionally, if a shape or an excitation condition of the ferromagnetic material meets an excitation condition of a spin wave, part of the magnon may also form a long-range ordered spin wave excitation.

In an embodiment of the present disclosure, the ferromagnetic material is a magnetic alloy containing at least one metallic element of iron, cobalt and nickel, a multilayer heterojunction or a magnetic insulator.

For example, the ferromagnetic material may include CoFe, CoFeB, NiFe, CoNi, a Pt/Co multilayer film, Y₃Fe₅O₁₂, Fe₃GeTe₂, Cr₂Ge₂Te₆, Tm₃Fe₅O₁₂, etc.

In an embodiment of the present disclosure, the antiferromagnetic material is an antiferromagnetic alloy containing at least one metallic element of iron, cobalt, nickel, manganese and chromium, a multilayer heterojunction or an antiferromagnetic insulator.

For example, the antiferromagnetic material may include IrMn, PtMn, NiOx, FeOx, Cr₂O₃, etc.

In an embodiment of the present disclosure, the ferromagnetic material has a vertical magnetic anisotropy or an in-plane magnetic anisotropy.

In an embodiment of the present disclosure, a Nie Er vector of the antiferromagnetic material is allowed to form an arbitrary angle with a transmission direction of a magnon.

In an embodiment of the present disclosure, the signal conversion module is provided in a functional module to be performed a data transmission, and the signal conversion module is electrically connected to the functional module.

During the data transmission, a voltage may be applied to the functional module to be performed a data transmission. Since the functional module is electrically connected to the signal conversion module, a voltage may be applied to the signal conversion module to enable the signal conversion module to work, or a voltage may be directly applied to the signal conversion module to enable the signal conversion module to work.

In the embodiments, when the data transmission is performed, the data transmission may be implemented through only the signal conversion module.

In an embodiment of the present disclosure, the signal conversion module is in contact with the signal transmission module, so as to transmit a magnon signal containing a to-be-transmitted data information on the signal transmission module.

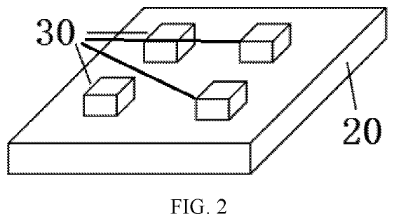

Further, the signal conversion module may be a portion of different functional modules within the same chip or a portion of different chips. The number of the signal conversion modules is at least two. In embodiments of the present disclosure, as shown in FIG. 2, four signal conversion modules are taken as an example for schematic description.

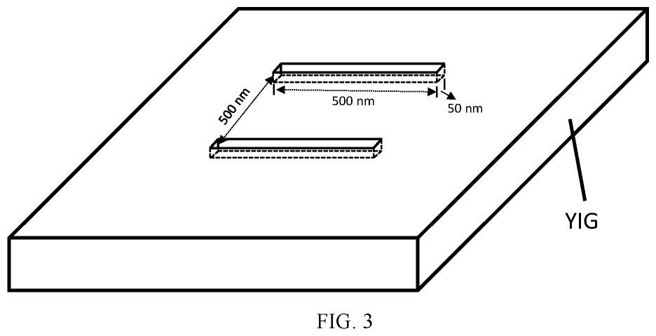

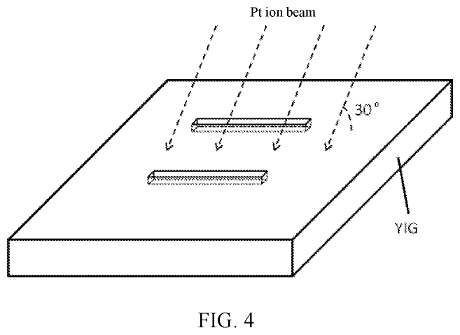

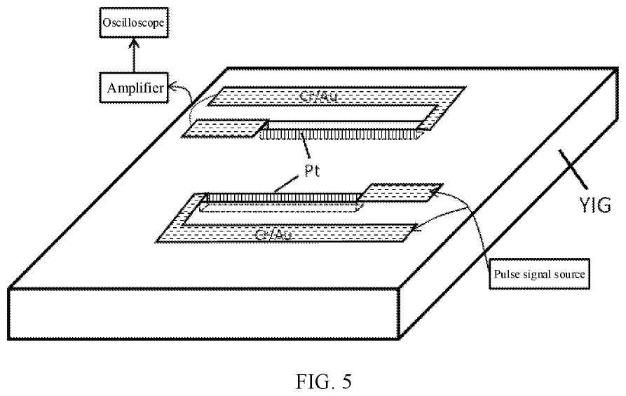

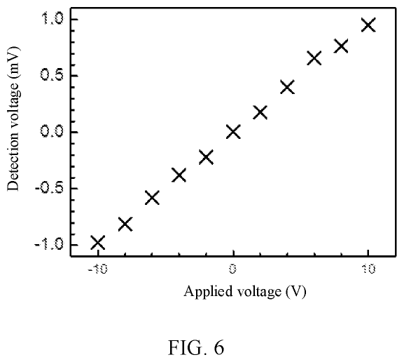

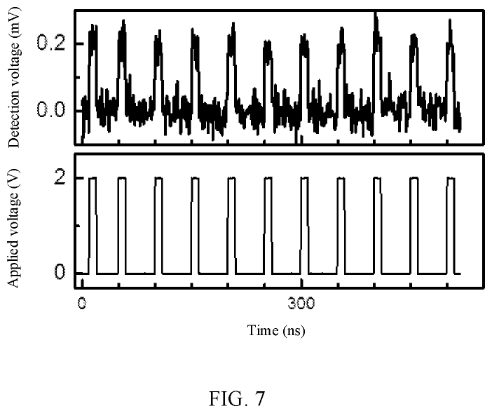

In an embodiment of the present disclosure, the signal transmission module uses ferromagnetic Y₃Fe₅O₁₂ (YIG), with a thickness of about 10 nm, and has the vertical magnetic anisotropy. The signal conversion module uses heavy metal Pt. In order to improve a conversion efficiency of a spin charge, a groove with a length of 500 nm and a width of 50 nm is first carved on a YIG film by photolithography and ion etching. As shown in FIG. 3, a distance between two grooves is 500 nm. It should be noted that after the ion etching, an electron beam glue remains on a YIG surface. Then, Pt of 6 nm is deposited on YIG by magnetron sputtering. During sputtering, an included angle between a magnetron sputtering target and a sample surface is 30 degrees. As shown in FIG. 4, the glue is removed after the sputtering. Finally, a coplanar waveguide and an electrode of Cr 10 nm/Au 100 nm are re-deposited by photolithography and magnetron sputtering so as to be used for a high-frequency signal test. A sample after a preparation is shown in FIG. 5. The coplanar waveguide is not necessary in an actual design. In the embodiments, the electrical signal is generated by an external signal source. The coplanar waveguide is used to transmit and receive a high-frequency signal more effectively. FIG. 6 shows a relationship between a detection voltage and an applied voltage, which proves that the electrical signal is transmitted through the magnon signal. FIG. 7 shows a relationship between an applied 10 nanosecond pulse sequence and a detected pulse sequence, which proves an effectiveness of a magnon transmitting an encodable pulse sequence from another aspect. It should be noted that the above-mentioned specific values are optional values, and those skilled in the art may make other changes with the same effect to the above-mentioned values without departing from the core idea of the present disclosure.

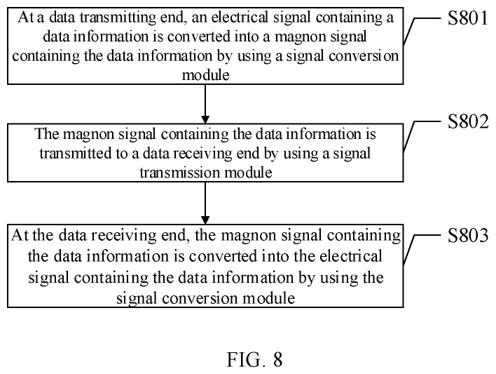

Please refer to FIG. 8. FIG. 8 shows a schematic diagram of a flowchart of a data transmission method according to an embodiment of the present disclosure. The method is implemented by the data transmission device shown in FIG. 1. The data transmission method includes steps S801 to S803.

S801. At a data transmitting end, an electrical signal containing a data information is converted into a magnon signal containing the data information by using a signal conversion module.

S802. The magnon signal containing the data information is transmitted to a data receiving end by using a signal transmission module.

S803. At the data receiving end, the magnon signal containing the data information is converted into the electrical signal containing the data information by using the signal conversion module.

The signal conversion module has a function of a mutual conversion between a spin and a charge.

The signal conversion module includes a material or a structure with a spin hall effect, a Rashba effect or a spin transfer torque effect, for example, a magnetic tunnel junction or an interface between two non-magnetic materials.

Optionally, a material of the signal transmission module includes a ferromagnetic material or an antiferromagnetic material.

Optionally, the ferromagnetic material is a magnetic alloy containing at least one metallic element of iron, cobalt and nickel, a multilayer heterojunction or a magnetic insulator.

Optionally, the antiferromagnetic material is an antiferromagnetic alloy containing at least one metallic element of iron, cobalt, nickel, manganese and chromium, a multilayer heterojunction or an antiferromagnetic insulator.

Optionally, the ferromagnetic material has a vertical magnetic anisotropy or an in-plane magnetic anisotropy.

Optionally, a Nie Er vector of the antiferromagnetic material is allowed to form an arbitrary angle with a transmission direction of a magnon.

Optionally, the signal conversion module is provided in a functional module to be performed a data transmission, and the signal conversion module is electrically connected to the functional module.

Optionally, the functional module to be performed a data transmission is in contact with the signal transmission module, so as to transmit a magnon signal containing a to-be-transmitted data information on the signal transmission module.

It should be noted that for the sake of simple description, the above-mentioned method embodiments are all described as a series of action combinations. However, those skilled in the art should know that the present disclosure is not limited by the described action sequence, because some steps may be performed in other sequences or simultaneously according to the present disclosure. Secondly, those skilled in the art should also know that the embodiments described in the specification are all preferred embodiments, and actions and modules involved are not necessarily necessary for the present disclosure.

In the above-mentioned embodiments, the descriptions of the embodiments have respective emphases. For a portion that is not detailed in an embodiment, please refer to relevant descriptions of other embodiments.

The above are descriptions of the data transmission device and a data transmission method according to the present disclosure. Those skilled in the art may make a change to the specific implementation mode and the application scope according to the idea of embodiments of the present disclosure. In summary, the contents of the specification should not be understood as a limitation of the present disclosure.

What is claimed is:

1. A data transmission device, comprising: a signal conversion module and a signal transmission module, wherein,
the signal conversion module is configured to convert, at a data transmitting end, an electrical signal containing a data information into a magnon signal containing the data information;
the signal transmission module is configured to transmit the magnon signal containing the data information to a data receiving end; and
the signal conversion module is further configured to convert, at the data receiving end, the magnon signal containing the data information into the electrical signal containing the data information.

2. The data transmission device according to claim 1, wherein the signal conversion module has a function of a mutual conversion between a spin and a charge; and
the signal conversion module comprises a material or a structure with a spin Hall effect, a Rashba effect or a spin transfer torque effect.

3. The data transmission device according to claim 1, wherein a material of the signal transmission module comprises a ferromagnetic material or an antiferromagnetic material.

4. The data transmission device according to claim 3, wherein the ferromagnetic material is a magnetic alloy containing at least one metallic element of iron, cobalt and nickel, a multilayer heterojunction or a magnetic insulator.

5. The data transmission device according to claim 3, wherein the antiferromagnetic material is an antiferromagnetic alloy containing at least one metallic element of iron, cobalt, nickel, manganese and chromium, a multilayer heterojunction or an antiferromagnetic insulator.

6. The data transmission device according to claim 3, wherein the ferromagnetic material has a vertical magnetic anisotropy or an in-plane magnetic anisotropy.

7. The data transmission device according to claim 3, wherein a Nie Er vector of the antiferromagnetic material is allowed to form an arbitrary angle with a transmission direction of a magnon.

8. The data transmission device according to claim 1, wherein the signal conversion module is provided in a functional module to be performed a data transmission, and the signal conversion module is electrically connected to the functional module.

9. The data transmission device according to claim 8, wherein the functional module to be performed a data transmission is in contact with the signal transmission module, so as to transmit a magnon signal containing a to-be-transmitted data information on the signal transmission module.

10. A data transmission method, comprising:
converting, at a data transmitting end, an electrical signal containing a data information into a magnon signal by using a signal conversion module;
transmitting the magnon signal containing the data information to a data receiving end by using a signal transmission module; and
converting, at the data receiving end, the magnon signal containing the data information into the electrical signal containing the data information by using the signal conversion module.
